(19) United States
(12) Patent Application Publication
(10) Pub. No.: US 2026/0099825 A1
(43) Pub. Date: Apr. 9, 2026

(54) AUTOMATED SYSTEM FOR LONG-TERM PLANNING AND EXECUTION OF PREVENTIVE AND CAPITAL REPAIRS WITH COST ESTIMATION AND ARTIFICIAL INTELLIGENCE INTEGRATION

(71) Applicant: Darya Stanskova, Clearwater, FL (US)

(72) Inventor: Darya Stanskova, Clearwater, FL (US)

(21) Appl. No.: 19/217,835

(22) Filed: May 23, 2025

(51) Int. Cl. G06Q 10/20; G06Q 30/0201

(52) U.S. Cl. CPC G06Q 10/20; G06Q 30/0206

(57) ABSTRACT

The invention relates to an automated system for long-term planning and execution of repair works and preventive maintenance, incorporating cost estimation and utilizing artificial intelligence (AI) technologies. The system integrates modules for generating repair schedules and work plans based on technical documentation and regulatory requirements, forecasting repair costs considering market fluctuations and inflation, monitoring actual repair execution, and dynamically adjusting plans in real time. The system implements the integration of technical and financial functionalities within a single platform, providing controlled and segregated access for specialists of various profiles. Additional features include automatic analysis of regulatory documents, market price monitoring, risk management, deviation analysis, occupational safety control, support for a digital technical council, and comprehensive information security compliant with international standards ISO/IEC 27001 and NIST guidelines. The system ensures efficient, accurate, and adaptive repair management and maintenance planning, optimizing resource utilization and reducing operational risks over the long term.

### TECHNICAL FIELD

The present invention relates to automated systems for managing production and technical processes. In particular, it concerns systems for long-term planning and execution of preventive maintenance and repairs (PMR) of industrial facilities and urban infrastructure.

The system includes modules for planning, cost estimation, execution of repair works, monitoring, and risk analysis.

Cost estimation accounts for market fluctuations and inflation.

The execution of repair works is monitored in real-time with the capability of automatic adjustments to the schedules.

Artificial intelligence is employed for analyzing regulatory requirements, forecasting costs, and managing risks.

The system enables digital interaction among participants in the repair process and implements role-based access control.

A comprehensive approach is realized for planning, controlling, and managing repair activities considering external factors and safety requirements.

The invention is aimed at improving the efficiency and reliability of repair management in industrial and urban infrastructure contexts.

The invention addresses critical inefficiencies caused by the separation of technical repair planning and financial budgeting processes, which often lead to misaligned schedules, cost overruns, and reduced operational transparency.

### BACKGROUND

At many industrial enterprises, repair planning—both capital and routine—is traditionally carried out using tools such as Excel, MS Project, or specialized ERP system modules. However, these tools do not provide dynamic integration with up-to-date repair cost estimates and budgets, which leads to manual recalculations, increased risk of errors, and discrepancies between technical and financial departments. Modern systems do not automatically update repair costs when schedules or work volumes change, reducing the efficiency and accuracy of planning.

Moreover, many industries use outdated or unsupported classification systems (for example, local estimate standards) that do not reflect real market prices and modern materials, and are not integrated with dynamic price databases. Information related to repair planning, defect reports, cost estimates, and work acceptance is often scattered across different systems or maintained on paper, which reduces transparency and complicates analysis and automation.

Despite the widespread use of modern computerized maintenance management systems (CMMS) and enterprise asset management (EAM) systems in the USA—such as IBM Maximo, SAP EAM, Oracle eAM, and others—these solutions typically do not include built-in modules for dynamic repair cost calculation linked to regulatory standards. Financial planning and budgeting are often conducted separately in ERP systems, requiring manual data reconciliation.

Similarly, estimating tools like RSMeans, Cleopatra Enterprise, and Sage Estimating are widely used for budgeting but operate independently from technical repair planning systems and do not perform automatic cost recalculations accounting for changes in schedules or equipment condition.

Furthermore, the application of artificial intelligence and advanced analytics in repair planning remains limited. Existing systems lack adaptive models that would recommend schedule adjustments based on data or forecast repair costs considering inflation and resource shortages.

There is a need for an integrated digital platform that combines repair planning and cost estimation in a single system. Such a platform would enable engineers, financiers, planners, and estimators to interact effectively, synchronize technical and financial data, automate cost recalculations, and implement AI for dynamic budgeting and procurement optimization.

Existing tools rely heavily on manual data reconciliation between technical and financial departments, resulting in increased errors, delays in decision-making, and inefficient resource allocation. The lack of dynamic cost updating linked to real-time repair progress further complicates budgeting and procurement.

### SUMMARY

The invention is an integrated digital platform designed to automate the planning and execution of capital and routine repair works in industrial enterprises and urban construction. The platform combines technical and financial planning functions, ensuring data synchronization among engineers, planners, financiers, and estimators. Unlike existing solutions, the platform automates real-time cost recalculations based on changes in schedules and work volumes, and integrates artificial intelligence for dynamic budgeting and procurement optimization. This significantly improves planning accuracy, reduces the risk of errors, and ensures transparency and efficiency in repair management processes.

Unlike traditional systems, where financial forecasting and technical planning are carried out in separate environments, the proposed invention provides synchronized real-time integration of these processes, allowing for prompt alignment of cost changes with repair plans.

The platform's core innovation lies in bridging the communication gap between engineers and financial specialists by providing a unified environment for collaborative planning, automated cost recalculations, and AI-driven risk and procurement management, leading to enhanced project control and reduced financial risks.

By integrating technical inspection reports, defect assessments, and financial planning into a single platform, the invention improves transparency and accountability across all stakeholders involved in repair management.

This integrated platform is crucial for optimizing capital and routine repair processes in both energy facilities and construction projects, ensuring improved reliability and cost-efficiency.

### BRIEF DESCRIPTION DRAWINGS

FIG. 1. Integration of Technical and Financial Aspects within a Unified Platform.

Functional integration of technical and financial aspects in a unified platform for repair planning and execution. The diagram illustrates key components including asset inventory, repair scheduling, cost estimation, budget planning, work volume calculation, execution monitoring, and documentation workflow.

FIG. 2. Block 1: Scheduling of Capital and Routine Repair Works with Financial Considerations.

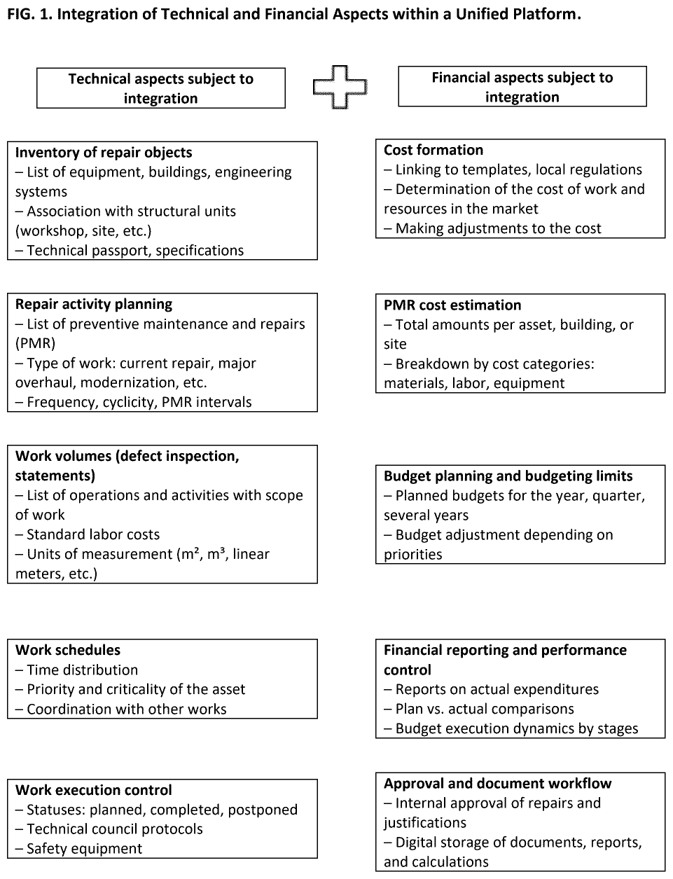

Block 1 integrates comprehensive asset information, including identification, technical characteristics, constituent components, and repair volumes. It incorporates AI-based analysis of country-specific regulations and standards, which are periodically updated in the system database every six months to ensure compliance.

The block generates an intermediate Scheduled Repair Plan that outlines the timing, frequency, and scope of repair tasks, differentiating between current (routine) and capital repairs in accordance with applicable national regulations and referencing relevant normative documents.

Cost estimates for both capital and current repairs are calculated externally and include detailed evaluations of labor and material resource requirements. These cost data are then imported into the system.

Finally, Block 1 produces a finalized repair schedule that visualizes the periodicity of repairs, detailed cost breakdowns by repair type and component, and quantities and costs of materials over a long-term planning horizon. The system employs AI to automatically adjust future cost projections accounting for inflation and price fluctuations, with customizable review intervals and automated alerts to managers about significant changes in material costs.

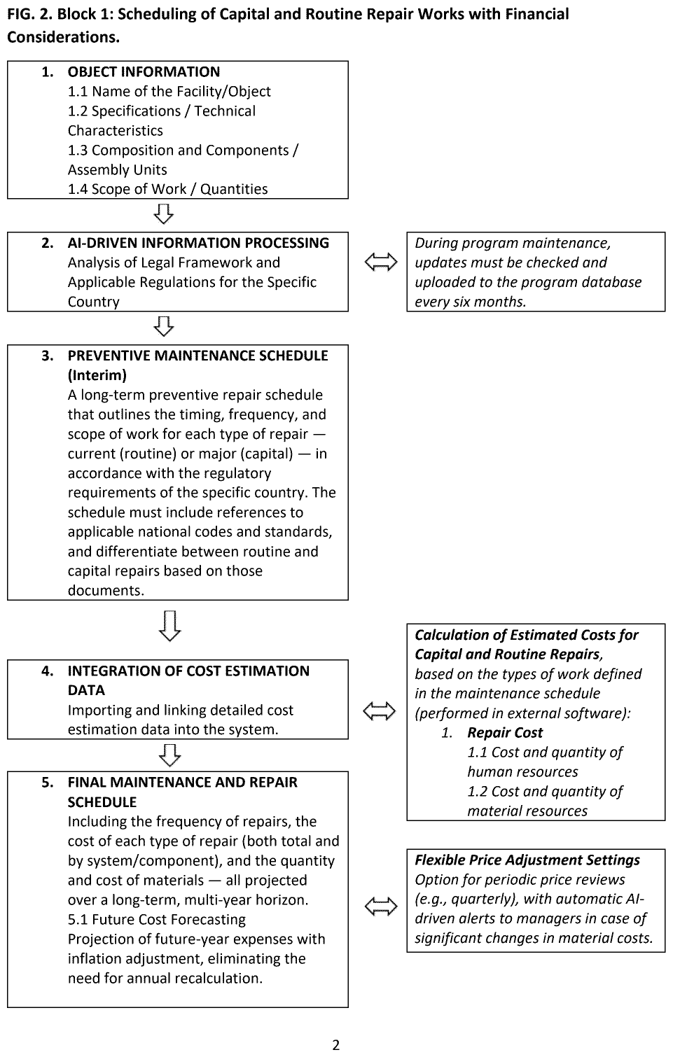

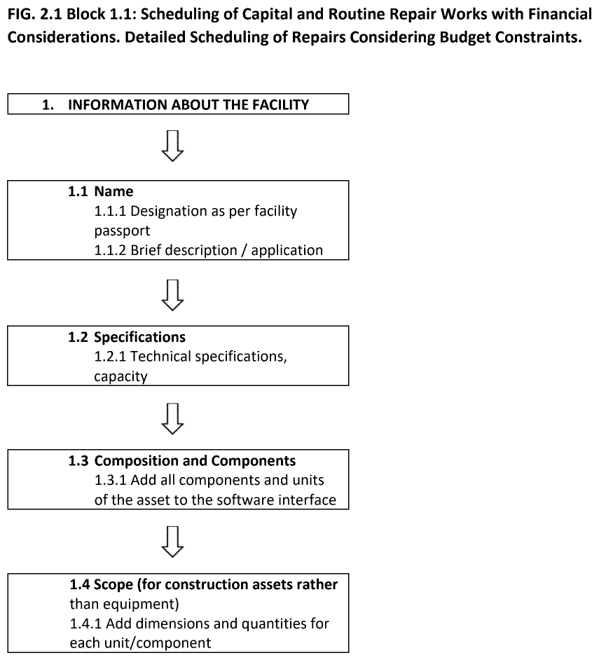

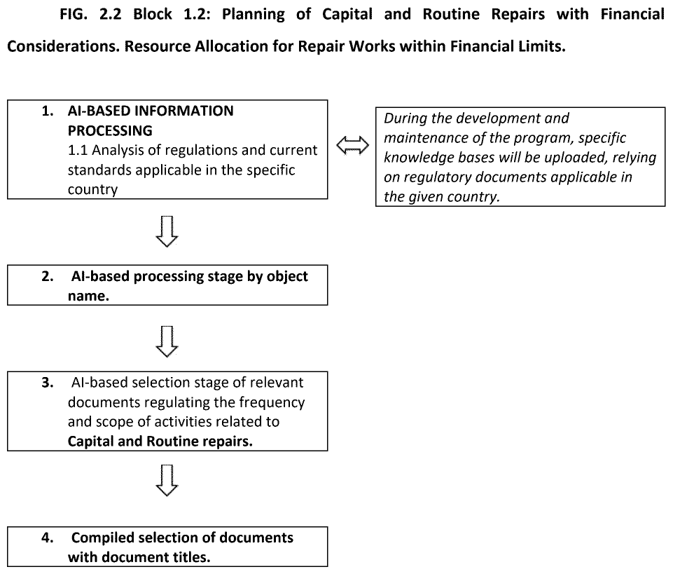

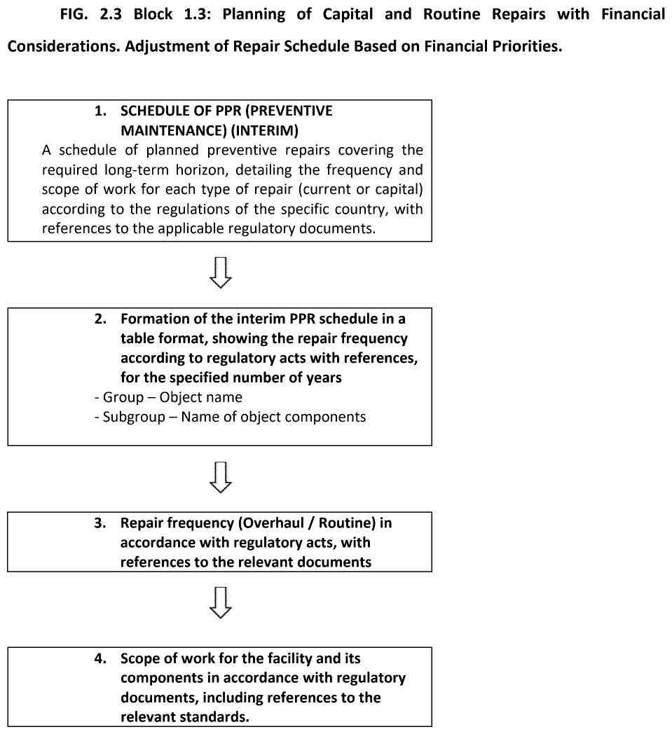

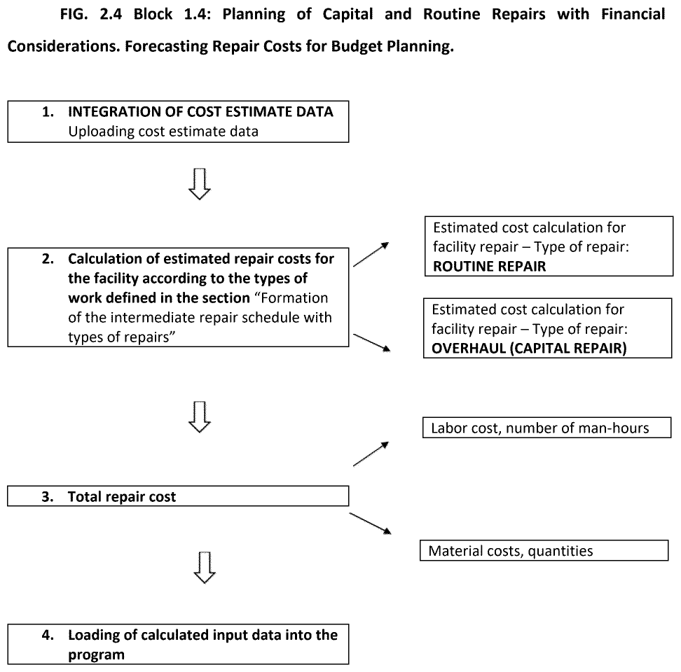

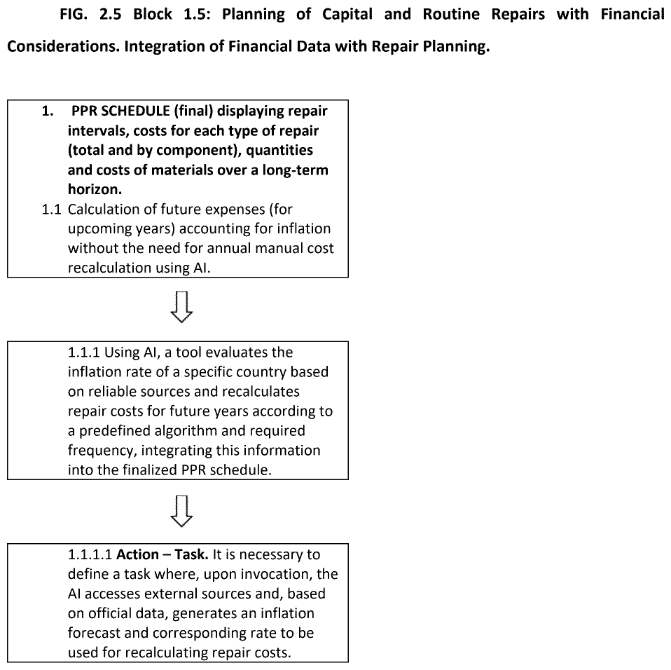

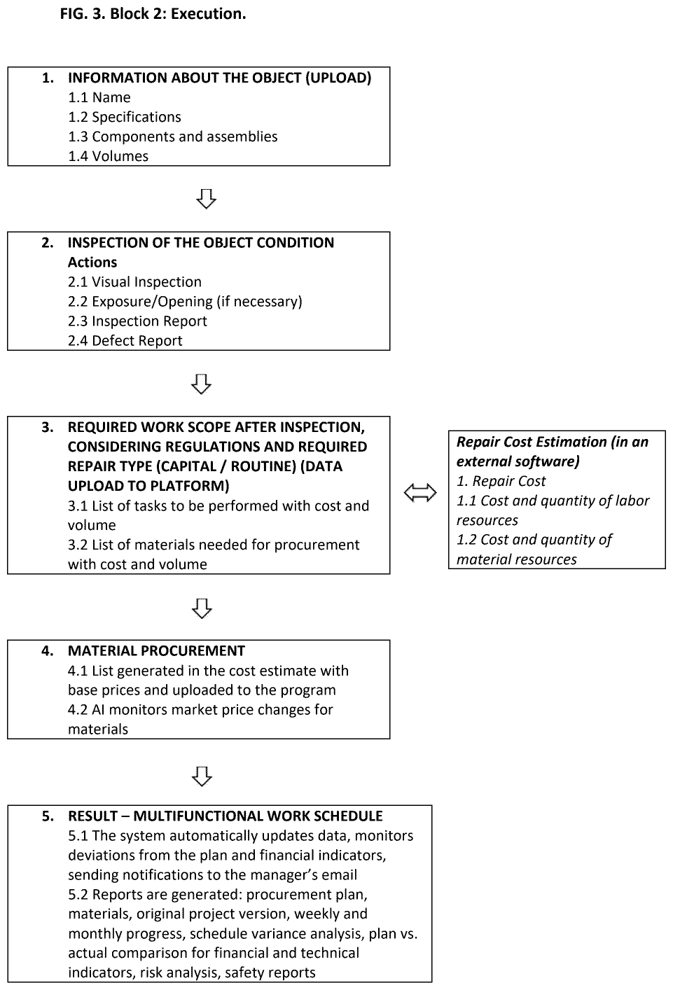

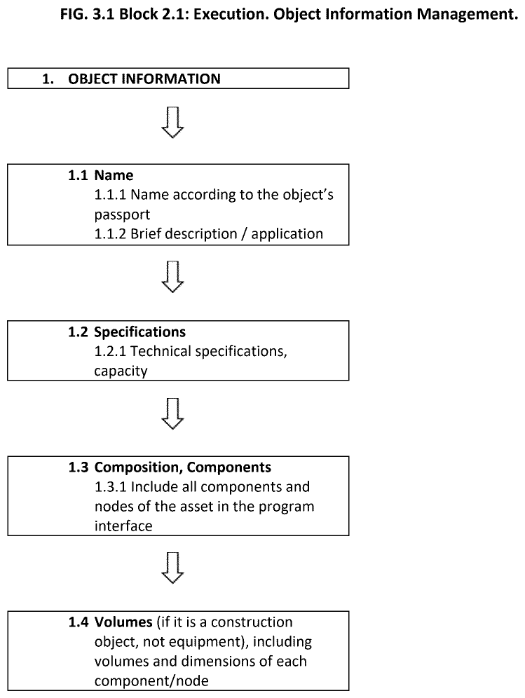

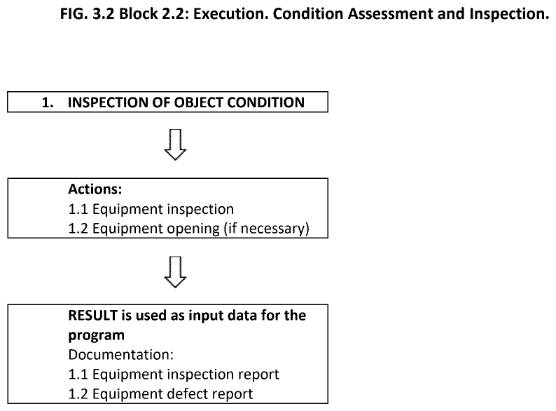

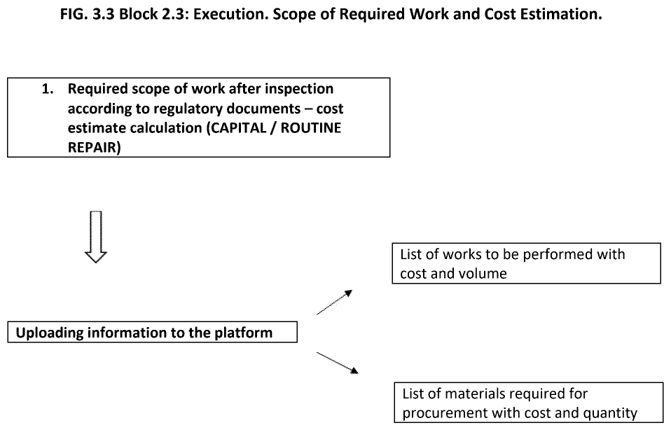

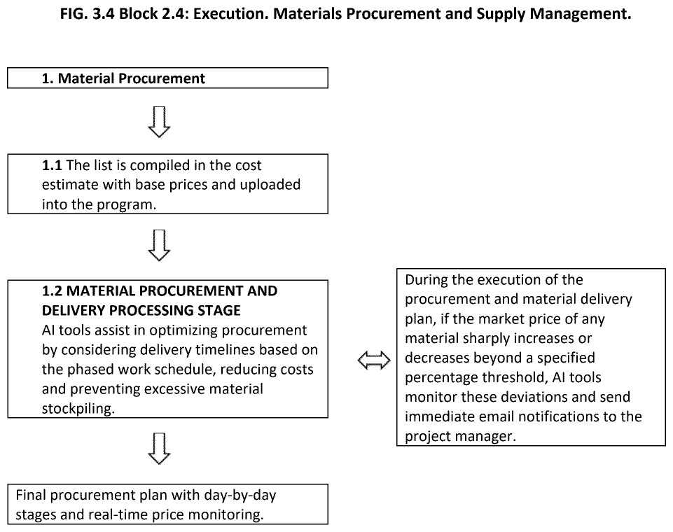

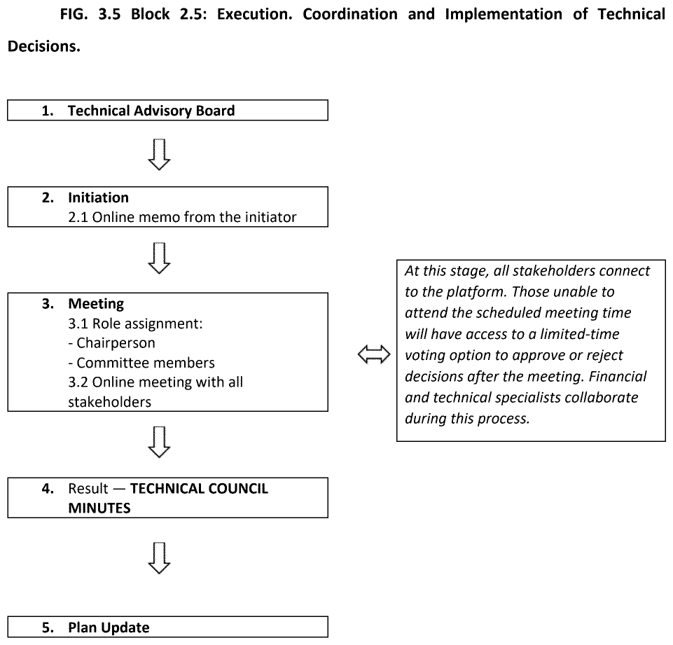

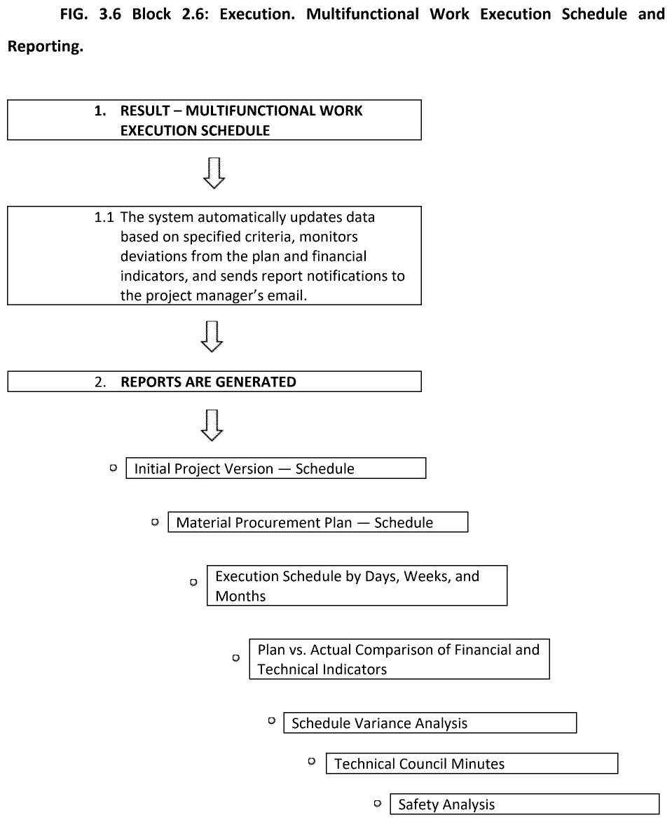

FIG. 2.1 Block 1.1: Scheduling of Capital and Routine Repair Works with Financial Considerations. Detailed Scheduling of Repairs Considering Budget Constraints.

Block 1.1 contains detailed information about the repair object. It includes the object's name as per its official documentation, as well as a brief description and its application.

Next, the technical characteristics of the object are described, including key parameters and power capacity, which are necessary for accurate repair planning.

The block also includes a detailed list of all components and nodes of the object, which are displayed in the program's user interface for convenient monitoring and management.

For construction objects, additional information on volumes and dimensions of each node is included to more precisely account for the scale of work and budget requirements when forming the repair schedule considering financial constraints.

FIG. 2.2 Block 1.2: Planning of Capital and Routine Repairs with Financial Considerations. Resource Allocation for Repair Works within Financial Limits.

This block describes the AI-driven processing of regulatory information for repair planning. It includes loading country-specific knowledge bases containing normative documents.

The AI analyzes these regulations based on the object's name, selects relevant documents that define the frequency and scope of capital and routine repairs, and compiles a finalized list of applicable regulatory references.

FIG. 2.3 Block 1.3: Planning of Capital and Routine Repairs with Financial Considerations. Adjustment of Repair Schedule Based on Financial Priorities.

This block describes the development of an interim repair schedule over a long-term planning horizon. It incorporates the periodicity and scope of repair activities, distinguishing between capital and routine repairs in accordance with country-specific regulations and referencing relevant normative documents.

The schedule is presented as a table grouping objects and their components, specifying repair frequency and detailed task lists linked to regulatory standards.

FIG. 2.4 Block 1.4: Planning of Capital and Routine Repairs with Financial Considerations. Forecasting Repair Costs for Budget Planning.

This block describes the process of uploading cost estimate data and calculating the projected costs for both routine and capital repairs based on the repair schedule.

It includes the calculation of labor and material resource costs, total repair expenses, and the integration of this data into the system for budget planning purposes.

FIG. 2.5 Block 1.5: Planning of Capital and Routine Repairs with Financial Considerations. Integration of Financial Data with Repair Planning.

This block represents the finalized repair schedule, detailing the frequency and cost of each type of repair (both overall and by component), as well as the quantities and costs of materials over a long-term planning horizon.

It includes automatic forecasting of future repair expenses, taking inflation into account, using AI that regularly updates data from official sources and integrates this information into the schedule for accurate budget planning.

FIG. 3. Block 2: Execution.

This block represents the execution stage of repair activities, starting from uploading asset information and conducting condition assessments, to forming a detailed list of repair works, procuring materials, and generating the final repair schedule.

The system integrates external data on estimated repair costs, applies regulatory requirements to classify repairs as current or capital, and automatically monitors deviations from the repair plan as well as fluctuations in market prices.

The output is a comprehensive execution schedule with detailed reporting features.

FIG. 3.1 Block 2.1: Execution. Object Information Management.

This block focuses on comprehensive management and digital representation of asset data necessary for the execution of repair works. It includes uploading the official name of the asset (as per documentation), a brief description and its application, technical specifications such as capacity, and a detailed list of all components and units. For construction assets, it also incorporates volumes and dimensions of each component.

This detailed asset profile serves as the foundational dataset for subsequent repair planning and execution processes.

FIG. 3.2 Block 2.2: Execution. Condition Assessment and Inspection.

This block covers the comprehensive condition assessment of the equipment, including visual inspection and, when necessary, equipment disassembly. The results of these activities are documented through inspection and defect reports, which serve as the primary input data for the repair management system.

FIG. 3.3 Block 2.3: Execution. Scope of Required Work and Cost Estimation.

This block defines the necessary scope of repair work following the condition assessment, considering relevant regulatory requirements. It includes the preparation of a detailed list of tasks categorized as capital or current repairs, along with their respective costs and volumes. Additionally, the required materials for procurement are identified with associated quantities and costs. All this information is uploaded into the platform for further planning and execution.

FIG. 3.4 Block 2.4: Execution. Materials Procurement and Supply Management.

This block covers the preparation and management of material procurement based on cost data imported from estimate calculations. During plan execution, AI tools monitor market price fluctuations for materials and automatically notify the project manager via email if deviations exceed predefined thresholds. AI also helps optimize the procurement schedule by aligning material deliveries with the phases of work, reducing costs and preventing excessive inventory. The final procurement plan includes detailed daily stages and real-time price monitoring.

FIG. 3.5 Block 2.5: Execution. Coordination and Implementation of Technical Decisions.

This block is responsible for coordinating and implementing technical decisions. It includes organizing meetings, appointing responsible persons, gathering and analyzing feedback from stakeholders, and controlling the incorporation of changes into the work plan to ensure successful project execution.

FIG. 3.6 Block 2.6: Execution. Multifunctional Work Execution Schedule and Reporting.

This block delivers a dynamic, multifunctional schedule for tracking work progress. The system automatically updates data based on preset criteria, monitors deviations from the plan and financial indicators, and sends reports and alerts to the project manager's email. Generated reports include the original project schedule, material procurement plans, detailed execution timelines by days, weeks, and months, plan-versus-actual comparisons on financial and technical metrics, schedule deviation analyses, technical council protocols, and safety analyses.

### DETAILED DESCRIPTION

The invention relates to the field of automation of preventive and corrective maintenance processes for equipment, buildings, and structures, with integrated financial planning and artificial intelligence (AI) elements. The proposed system is designed for industrial, energy, construction, and other facilities requiring scheduled maintenance, and aims to optimize the associated costs.

### 1. System Overview

The automated system is a modular digital platform comprising:
1. A maintenance planning module with integrated financial parameters;
2. A maintenance execution module featuring deviation control and analysis mechanisms;
3. A data updating mechanism for regulatory and pricing indexes;
4. An AI-driven alerting algorithm to notify users of market changes;
5. An interaction interface for technical and financial specialists;
6. A regularly updated database of regulatory documents.

The system operates through the integration of technical data, cost estimates, predictive analytics, and AI algorithms, providing full digital support for the entire maintenance lifecycle—from planning to execution and reporting.

### 2. Block 1—Maintenance Planning With Financial Integration

This module includes the following components:
Asset Identification: Loading technical specifications for the facility or equipment subject to maintenance.
AI-Driven Regulatory Analysis: Automated analysis of applicable standards and regulations (including country-specific industry requirements) and their application to the designated assets. Regulatory data is updated at least twice annually.
Maintenance Scheduling: Generation of a schedule for corrective and preventive maintenance, specifying task frequency, work volumes, cost indicators, operations list, and normative justification.
Cost Module: Linking maintenance activities to financial parameters, with detailed outputs including:
   1. Total cost;
   2. Labor cost and estimated man-hours;
   3. Bill of materials with unit and total prices.
Inflation and Price Forecasting: Projected cost calculation using AI algorithms based on inflation indices, price trends, and historical maintenance data.
Flexible Review Settings: Configurable frequency for automatic cost reviews (e.g., quarterly), with a notification system for significant deviations.

### 3. Block 2—Maintenance Execution

During the execution phase, the system performs the following functions:
Pre-Maintenance Review: Recording any deviations in scope or work volume prior to execution.
Procurement List Update: Dynamic generation of material requirements using AI-based forecasts, considering pricing, logistics, and delivery timelines.
Procurement Optimization: Minimizing overstock by synchronizing material deliveries with scheduled work stages.
Execution Monitoring and Control: Tracking deviations from the initial plan in terms of timing, cost, and technical specifications.
Automated Reporting: Generation of documentation, including:
   1. Material procurement plans;
   2. Planned-vs-actual comparisons;
   3. Weekly and monthly reports;
   4. Financial and technical deviations;
   5. Comparison of actual progress versus the initial project scope.

Although modules function autonomously, the system ensures continuous data exchange across all stages of the maintenance process. Maintenance schedules and cost parameters developed in Block 1 are automatically transmitted to Block 2 for execution. If deviations occur (e.g., in timelines, scope, or cost), data is fed into the reporting subsystem and used for automatic updates of future plans and financial estimates.

This continuous feedback loop minimizes manual data input and improves the system's adaptability to external conditions.

### 4. Automated Notification Mechanism for Repair Works

The AI algorithm monitors market prices for materials used in repair works and compares them with baseline values stored in the system.

### Functionality:

Price Monitoring: Integration with external supplier platforms and procurement portals to track current prices of repair materials.
Deviation Detection: When material prices fluctuate beyond a predefined threshold (e.g., ±20%), the system registers the deviation.
Notification Generation: Alerts are sent via user interface or email with:
   1. Material name and updated price;
   2. Source of pricing information;
   3. Recommendation to review repair budgets and schedules;
   4. Options to select alternative suppliers or adjust material quantities.
Change Processing: Upon approval from the project manager, the system:
   5. Automatically updates repair cost estimates;
   6. Adjusts repair work schedules accordingly;
   7. Revises procurement plans for repair materials.

### Use Case Example:

Previously, recalculations of repair costs and adjustments of schedules and material lists were performed manually and infrequently, causing delays and inaccuracies. The automated system now performs real-time recalculations based on current market prices and inflation indices, ensuring repair plans and budgets remain accurate and up-to-date. Any changes in costs or schedules instantly trigger updates in repair work sequences or project phases.

The platform supports role-based access control for editing, procurement approvals, and financial reviews—essential for managing repair projects at industrial enterprises. It also provides tools for resolving discrepancies between technical and financial teams through real-time negotiations and approval workflows. All changes to repair plans, costs, and timelines are logged for audit purposes. AI continuously learns from operational history and decision outcomes, enhancing future repair planning recommendations.

### 5. System Advantages for Repair Management

Unified integration of technical repair planning and financial management;
Minimization of errors due to siloed departmental processes;
Enhanced transparency and control over repair projects;
Support for long-term repair planning up to 10 years;
Accelerated generation of repair schedules, budgets, and reports;
Fast adaptation to market price fluctuations and regulatory updates affecting repair works;
Strategic management of repair activities at enterprise and industry levels.

1. Output data of the system are long-term PMR schedules with forecasted repair cost calculations based on initial cost and quantitative data obtained from estimates or other sources, these calculations are not local formal estimates and are intended for long-term planning and budget evaluation considering market changes and inflation; an automated system for long-term planning and execution of preventive maintenance and repair (PMR) with cost calculation and use of artificial intelligence (AI), comprising:
a) a planning module configured to generate schedules for preventive maintenance and repair of assets based on technical documentation, regulatory requirements, and equipment condition parameters;
b) a cost estimation module configured to determine expenses for performing repair activities taking into account changes in market cost indicators from external sources, including recalculation of labor costs, work volumes, and required materials based on externally provided quantitative data, wherein the module does not perform volume calculation but only recalculates costs according to input data; the cost estimation module is not an estimating software but uses quantitative data obtained from estimates or other sources for automated determination of labor costs, materials, and work volumes;
c) an execution module configured to monitor actual performance of repair activities, collect data from execution sites, control deviations from schedules, and automatically adjust the plan in real time.

2. The system of claim 1, wherein a regulatory documentation analysis module is implemented with the capability to automatically search for and download regulatory acts applicable in a specific country, followed by extracting requirements for frequency and scope of repair works using artificial intelligence, thereby adapting repair planning to local legal and technical standards, reducing manual analysis, and minimizing errors related to regional specifics.

3. The system of claim 1, wherein the cost estimation module forecasts repair costs several years in advance considering inflation and market fluctuations, using data from official external sources collected and analyzed automatically via connections to government and financial agencies, with the possibility for manual revision of cost indicators by a user if actual inflation deviates significantly from the forecast.

4. The system of claim 1, wherein a market price monitoring module continuously collects and analyzes data on the cost of materials and services from trading platforms and supplier websites, generating operational reports on price changes including notifications (e.g., via email) to managers about advantageous opportunities for contract revision or supplier selection to save budget; the module allows flexible report generation settings such as weekly market analysis with price fluctuation detection, enabling managers to plan procurement, revise contracts, and change suppliers promptly; it provides supplier selection recommendations based on comprehensive market data analysis, price history, and reliability metrics; after manager confirmation, the module recalculates repair cost estimates and adjusts repair schedules, coordinating economists and technical specialists during repair execution.

5. The system of claim 1, wherein a deviation analysis module performs regular comparison of planned and actual indicators regarding volume, timing, and costs based on data input by a manager, with automatic generation of visual reports and notifications upon significant deviations.

6. The system of claim 1, wherein the deviation analysis module additionally monitors occupational safety indicators, collecting, comparing, and visualizing data on incidents, non-compliance, and fulfillment of safety requirements, as well as generating AI-based recommendations to reduce risks and prevent accidents.

7. The system of claim 1, comprising an access rights and role management module, configured to:
a) assign individual rights to users (planner, estimator, purchaser, project manager, engineer, economist, etc.) for viewing, inputting, editing, and approving data;
b) configure access levels to key system functions depending on the role;
c) implement an approval procedure for changes through submission of requests with justification to the project manager prior to modifying data.

8. The system of claim 1, comprising a digital technical council function, providing:
a) initiation of a service note within the system with a description of the reason for change and forwarding it to the project manager;
b) holding an online technical council involving all necessary specialists according to roles approved in the system;
c) automatic documentation of decisions in a digital protocol;
d) transferring the approved protocol to the planning department for schedule and budget update, with subsequent notification of procurement units and recalculation of work execution parameters in the system.

9. The system of claim 1, wherein a risk management module using artificial intelligence performs:
a) automatic identification of potential risks at the project planning stage, considering data on timing, budgets, work types, team composition, and external factors;
b) formation of a preliminary risk register indicating probability, impact, categories (in accordance with PMI guidelines and PMBOK standards);
c) regular risk reassessment during execution based on incoming actual data, including addition of new risks upon detection of deviations;
d) generation of reports visualizing current and potential risks, their ratings, responsibility areas, and possible mitigation measures;
e) issuance of warnings and recommendations to managers upon reaching a predetermined risk level (e.g., budget reserve exceedance or critical path at risk).

10. The system of claim 1, wherein the modules can operate autonomously while ensuring end-to-end integration based on a common data architecture, allowing the system to be used as a single package or in stages.

11. The system of claim 1, wherein it comprises an information security module that implements:
a) access level segmentation using multi-factor authentication for system login;
b) data encryption during transmission and storage using up-to-date cryptographic protocols;
c) user activity logging with the capability for subsequent audit of changes and actions within the system;
d) automatic detection and notification of unauthorized access attempts and abnormal activity, including through the use of machine learning algorithms;
e) backup management and data recovery in the event of system failures or data loss, maintaining full version history of key documents and protocols;
f) compliance with the international standard ISO/IEC 27001 and compatibility with the U.S. National Institute of Standards and Technology (NIST) recommendations, including the NIST Cybersecurity Framework.
